(19) United States
(12) Patent Application Publication
(10) Pub. No.: US 2004/0207440 A1
(43) Pub. Date: Oct. 21, 2004

(54) Electrical circuit for controling another circuit or system

(76) Inventors: Naysen Robertson, Orangevale, CA (US); Ben Percer, Roseville, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/418,543

(22) Filed: Apr. 17, 2003

(51) Int. Cl. G06F 1/04

(52) U.S. Cl. 327/291

(57) ABSTRACT

A control circuit that provides a control signal to control, e.g., the hardware system of a server is disclosed. The control circuit operates based on the condition of the Baseboard Manageability Controller (BMC). Asserting the control signal turns on the hardware system, and the control circuit asserts the control signal when the control circuit has not received a heartbeat pulse from the BMC for more than a predetermined time. Further, the BMC is programmed to revoke generation of its heartbeat signal once it has completed initialization, and the BMC is programmed to deterministically generate a heartbeat within a predetermined time-period triggered on connection of AC power to the system.

### FIELD OF THE INVENTION

The present invention relates generally to electrical circuits and, more specifically, to a circuit that controls another circuit or system.

### BACKGROUND OF THE INVENTION

Many servers today integrate out-of-band manageability devices that monitor and control the servers' system hardware, facilitate and control both standard and custom manageability services, including, for example, system diagnostics, environmental monitoring, 12C/SMbus mastering, information passing to externally-connected system administrators, etc. Devices such as these are often compliant with the Intelligent Platform Management Interface (IPMI) industry standard and implemented in the form of Baseboard Manageability Controllers (BMCs), which typically include their own processing element, memory, and firmware code to enable programmability and specialization per design needs. To take full advantage of these powerful BMC services, power-on of the core system to be controlled must be delayed until the completion of BMC initialization.

BMCs commonly make use of a “healthy” status-signal that feeds system power control logic in such a way as to guarantee that the system will not power-on until the BMC has completed its initialization code. This signal indicates that the BMC is fully initialized and ready to perform its function. In an approach, the BMC receives its voltage power from an un-switched standby power source and delays switching-on the core system power, and thus the power-on self-test (POST) bootstrap, until the BMC has initialized. As implied above, delaying the switching-on of main system power provides several benefits. For example, logging features enabled in the BMC, such as the SEL (system event logs) and FPL (forward progress logs), can be operational during early system boot, which is a crucial time for error logging during which tens to hundreds of diagnostic tests and their results may transpire in just as many milliseconds. Saving these logs for later review and/or providing boot-concurrent monitor of them to externally connected users, the BMC plays an important role in enabling key administrative functions. As described, in this design scheme, the BMC is required to be initialized and healthy to accept incoming system messages and enable remote connectivity before the main system power is switched on. As a result, the main system becomes more dependent on the BMC for normal operation, and this dependency may constitute a single-point of failure (SPF) in certain fail scenarios. For example, if the BMC fails to properly initialize, then the system will not be switched on and becomes inoperable because of the BMC's failure that is not related to the core system function.

In another approach, to provide the system's power-on control, the system proceeds through the system boot without consideration for the BMC status. However, in this approach, resolution to POST errors encountered in the early boot process is lost. That is, the ability to log incoming messages is lost while the BMC is busy initializing. Furthermore, the ability to monitor the boot-console via remote access is lost during early system boot.

One alternative approach triggers a hard countdown-timer with each AC power-cycle/power-on event in which, when the timer expires, the BMC-healthy trap is bypassed and core system power is switched on. However, if a BMC failure occurs, then a delay equal to the time of the timer countdown still ensues before the main system is powered on. This approach also increases risk that an oversight in firmware validation could lead to undesirable results under unforeseen operating conditions. Were a new module enabled in the BMC that required processing time for its own setup and initialization, a re-evaluation of the counter delay time would be necessary to ensure proper timer function. This would complicate the roll-out implementation of a field firmware update and, furthermore, require that the countdown timer be soft-programmable. In systems where the BMC is available as a configuration option, such as an add-in PCI card, design is complicated, as the main system could be delayed at power-on if the healthy signal is not forced to an asserted state by default.

Based on the foregoing, it is desirable that mechanisms be provided to solve the above deficiencies and related problems.

### SUMMARY OF THE INVENTION

The present invention is related to a control circuit that provides a control signal to control a first circuit or system, based on the condition of a second circuit or system. In an embodiment, the first circuit is the hardware system of a server and the second circuit is the system Baseboard Manageability Controller (BMC). The BMC generates a “heartbeat” to be monitored by the control circuit. The heartbeat is a periodically repeating digital pulse that is generated within a predefined, design calibrated time-window. Asserting the control signal authorizes turn-on of the server-system's core power, and is materialized when one of two monitored conditions transpires: (1) the BMC completes initialization and disables the heartbeat signal; (2) the BMC encounters error(s) and cannot produce the heartbeat signal within a predefined time-window.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows a circuit upon which embodiments of the invention may be implemented;

FIG. 2A shows a first embodiment of the control circuit in FIG. 1;

FIG. 2B shows a timing diagram to illustrate the operation of the control circuit in FIG. 2A;

FIG. 3A shows a second embodiment of the control circuit in FIG. 1;

FIG. 3B shows a timing diagram to illustrate the operation of the control circuit in FIG. 3A; and

FIG. 4 shows a circuit that may be used to provide an input voltage and a reset mechanism for the control circuit in FIG. 3A.

### DETAILED DESCRIPTION OF THE PREFERRED EMBODIMENT

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

### Overview

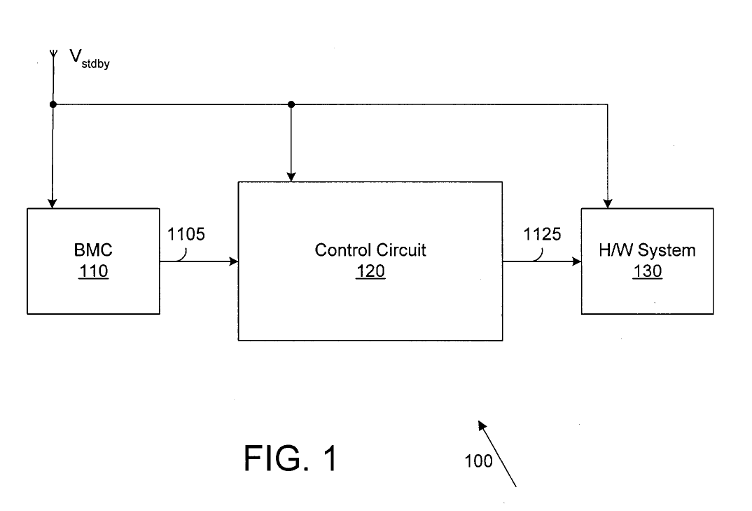

FIG. 1 shows a system 100 upon which embodiments of the invention may be implemented. System 100 includes a circuit 110, a circuit 120, and a circuit 130, which may be referred to as Baseboard Manageability Controller (BMC) 110, control circuit 120, and hardware system 130 of a server.

BMC 110 is a service processor providing services for server 130, and, in an embodiment, is compliant with the IPMI standard for monitoring and controlling servers. BMC 110 is plugged in system 100 through an input/output (I/O) slot. However, BMC 110 may be embedded within system 100 and connected through a communication bus of a given protocol. Alternatively, BMC 110 may be external to the system and connected by cable. BMC 110 facilitates functions such as remote console access, event and error logging, etc. Normally, when system 100 is powered on, a series of diagnostic tests ensue on system 100, and, if there is no problem, a power-on self-test (POST) success code is generated. Examples of diagnostic tests include processor and memory built-in self-tests (BISTs), module recognition, I/O discovery and configuration, video initialization, etc. Event logs provide a history of system activities during power-on and thus help identify problems, if any, during the power-on process. BMC 110 also provides an interface port for external console access, which enables remote, out-of-band system administration of system 100. By this a system administrator may perform system administration such as observing the boot process, viewing and/or modifying basic I/O system (BIOS) setup parameters, responding to system management messages, etc., without utilizing the hardware system and/or operating system resources. In such situations, BMC 110 may include a network interface to an external network such as a local area network (LAN) through Ethernet. Upon AC power on, BMC 110 and control circuit 120 receive standby-power in parallel. Standby power may also route to devices on the core system 130 where necessary and, in such case, is not under the control of circuit 120.

BMC 110 provides a “heartbeat” on line 1105 before a predefined time-period expires. This period starts when BMC 110, control circuit 120, and core system 130 receive standby power. In general, a heartbeat is a periodic repeating pulse, and, in an embodiment, is in the range of 1 Hz-100 KHz. If BMC 110 encounters a problem, then the heartbeat signal is not generated and the signal on line 1105 remains a logic low so that circuit 130 can power-on within the timeout period. However, if BMC 110 operates properly, then it generates the heartbeat signal that remains active until BMC 110 is ready to function and/or completes its initialization. Following completion of its initialization, BMC 110 revokes or de-asserts its heartbeat signal, by, for example, providing a logical low on line 1105.

Control circuit 120 may be implemented in a Field Programmable Gate Array (FPGA), Programmable Logic Devices (PLDs), discrete logic devices, etc., or their equivalences. Circuit 120 monitors the heartbeat on line 1105 of BMC 110 from which circuit 120 provides appropriate logic levels to the control signal on line 1125 that is used to control system 130. In an embodiment, asserting the control signal on line 1125 turns on system 130. The active logic level of the control signal on line 1125 varies depending on the requirement of system 130. For example, if turning on system 130 requires a logical high, then control circuit 120 provides a logical high on line 1125. Conversely, if turning on system 130 requires a logical low, then control circuit 120 provides a logical low on line 1125. Those skilled in the art will recognize that, an inverter may be used to switch the logic state of the control signal on line 1125, e.g., from a logic low to a logic high, or vice versa. Generally, embodiments of the invention are also applicable when the control signal is pulsing. For example, the control signal provides a pulse to turn on circuit 130, etc.

Circuit 130 is a hardware system of a server including, for example, processor, memory, input/output (I/O) bridges, etc. However, various embodiments of the invention cover other circuits and/or system that can be controlled by the control signal on line 1125. Further, the control signal may originate from a circuit or system other than BMC 110. For example, the input interface for circuit 130 may represent a PLD that drives various system power-converter enable pins and controls cycling power states for the system, interacting with the SuperIO, system hotswap controllers, and other similar devices. Normally, circuit 130 includes its own reset capability so that it has enough time to prepare for its operational functions once it is turned on by the control signal on line 1125.

Standby power is applied to circuits 110, 120, and 130 as soon as AC power is applied to the power cord for system 100. This standby power provides power for management devices such as BMC 110 and other devices such as Ethernet chip(s) for wake-on-LAN (WOL), status-reporting power converters, system sensors for voltage, frequency, temperature, etc., in system 100.

### First Embodiment of the Control Circuit

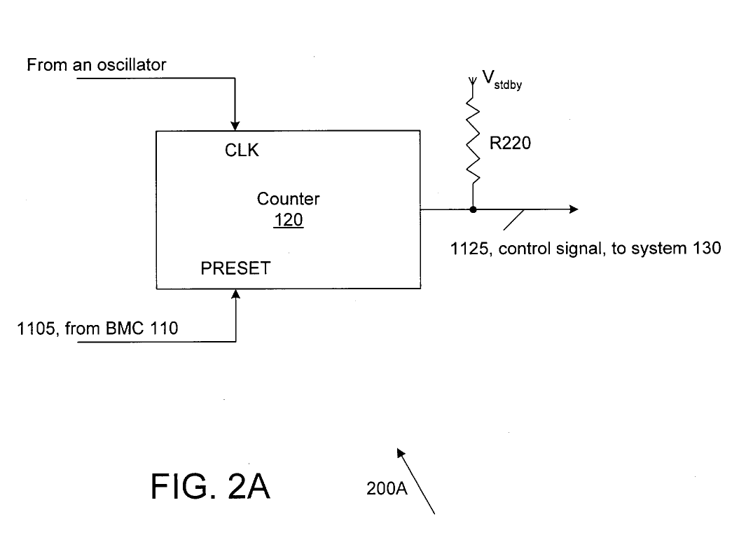

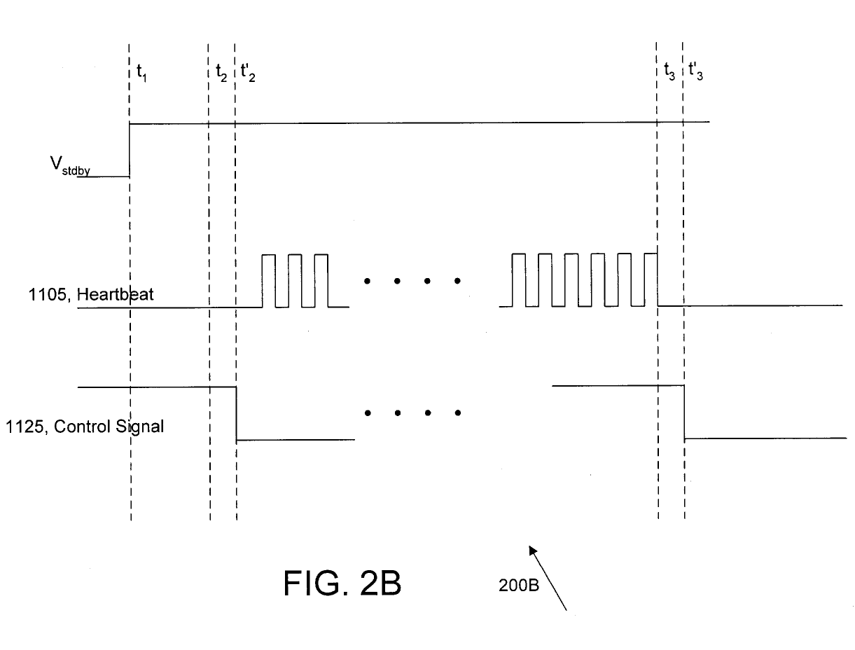

FIG. 2A shows a circuit 200A being a first embodiment of control circuit 120. In this embodiment, for illustration purposes, the control signal on line 1125 is asserted with a logical low to turn on system 130, and this control signal is de-asserted with a logical high. Circuit 200A is implemented with a counter 210 and a pull-up resistor R220 that is tied to standby power.

Counter 210 asserts a logical low to the control signal on line 1125 when counter 210 does not receive the heartbeat pulse for a predetermined time, which, in an embodiment, is 2 ms. Generally, the preset pin of counter 210 receives the heartbeat signal on line 1105 as input, and when this pin detects a rising-edge pulse to a logical high, counter 210 is set to the predefined value of, e.g., 2 ms, to count down. At the same time, the control signal one line 1125 is de-asserted, e.g., provided with a logical high. When counter 210 counts down to zero, the control signal on line 1125 is turned from a logical high to a logical low. To perform its counting function, counter 210 also receives, at its clock input, signals from an oscillator, which generates an appropriate clock frequency.

The value of resistor R220 is selected based on various factors including how quick the control signal on line 1125 is desired to reach the level of standby power, the current sinking ability of counter 210, etc. The faster the time for the control signal to reach standby power, the smaller value of resistor R220 is selected; conversely, the slower the time, the higher value is selected. In an embodiment, resistor R220 is at 1K OHM.

### Timing Diagram to Illustrate the Operation of System 100 that uses Circuit 200A

FIG. 2B shows a timing diagram 200B illustrating the operation of system 100 that uses circuit 200A, in accordance with an embodiment. For illustration purposes, BMC 110, control circuit 200A, and system 130 receive a valid V_{stdby} at time t₁; system 130 is in reset at time t₁ until time t₂, and does not monitor the control signal on line 1125 until time t₂; a period P of 500 ms lasts between time t₁ and t₂; and BMC 110 completes its initialization at time t₃. Further, if BMC 110 generates a heartbeat signal, then the signal on line 1105 will be pulsing before time t₂.

At time t₂, if the heartbeat signal has not been generated, e.g., the signal on line 1105 is not pulsing, then counter 210, after another countdown period T_{c} of 2 ms, i.e., at time t′₂, asserts the control signal on line 1125 to turn on system 130. As shown in FIG. 2B, at time t′₂, the control signal on line 1125 turns low. In this example, system 130 is turned on after a predefined time window of P plus T_{c}.

However, if, at time t₂, the heartbeat signal is pulsing, i.e., the heartbeat has been generated, then BMC 110 continues its initialization and is ready to function and/or completes its initialization at time t₃. At that time, BMC 110 de-asserts the heartbeat signal, e.g., for it to stay at a low level. Consequently, after the countdown period T_{c} of 2 ms from time t₃, i.e., at time t′₃, counter 210 asserts the control signal on line 1125. As shown in FIG. 2B, at time t′₃, the control signal on line 1125 turns low.

### Second Embodiment of the Control Circuit

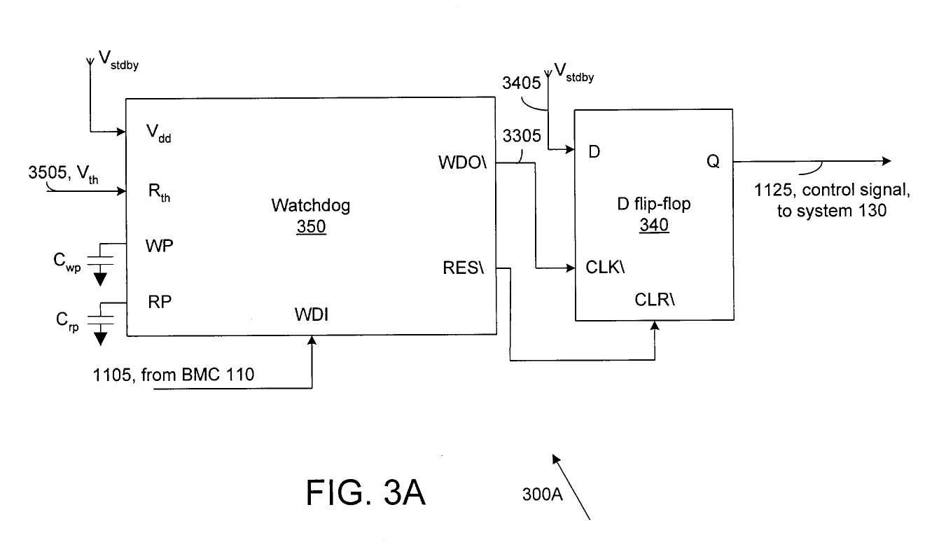

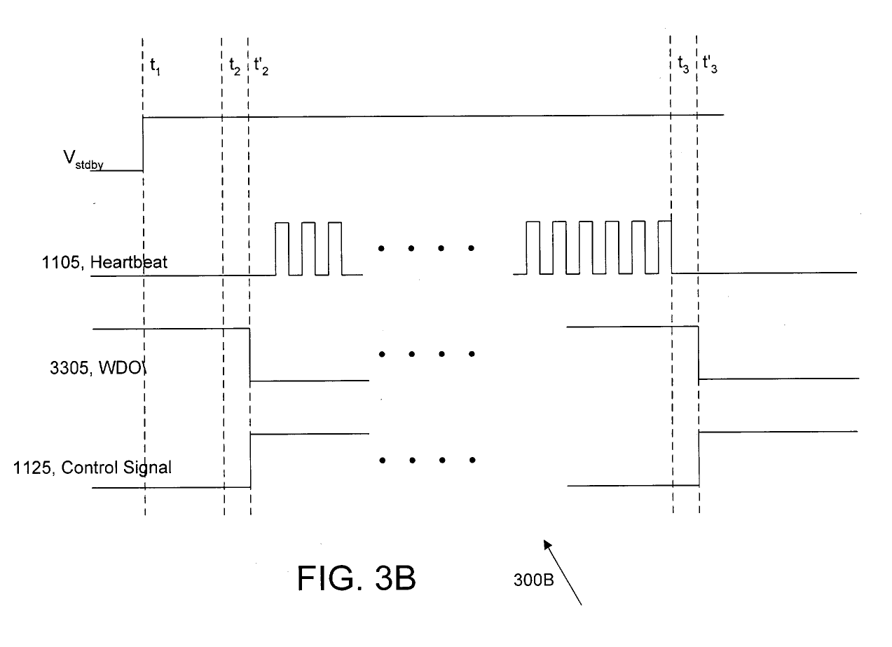

FIG. 3A shows a circuit 300A being a second embodiment of control circuit 120. Circuit 300A includes a D flip-flop 340 and a device 350. Device 350, in an embodiment, is a UCC3946, which is in a family of Microprocessor Supervisor with Watchdog Timers by Texas Instruments of Dallas, Tex. Equivalences of device 350 are within the scope of embodiments of the invention. In effect, device 350 performs functions of circuit 210 with some additional features. Inputs of device 350 include R_{TH}, WP, RP, and WDI, and outputs of device 350 include WDO\ and RES\. The “\” at the end of a pin name indicates that that pin is active low. For illustration purposes, circuit 300A asserts a logical high on line 1125 to control system 130.

D flip-flop 340 passes the data at the D input on line 3405 to the Q output on line 1125 upon an active edge of the clock at the clock input on line 3305. Depending on implementations, D flip-flop 340 may be positive-edge triggered or negative-edge triggered. In a positive-edge-trigger, the rising-edge of line 3305 triggers the flip-flop for the data to be transferred from the D input to the Q output. However, in a negative-edge trigger, a falling-edge at the clock input triggers the flip-flop. Other circuits performing the equivalent function of a D flip-flop are within the scope of embodiments of the invention. In FIG. 3, the D input is tied to the standby power on line 3405, and thus is generally at a logical high. As a result, the output Q on line 1125 is generally at a logical low and is turned high by the logical high of the standby power on line 3405, upon the active edge of the clock on line 3305.

Pin Rₜₕ of device 350 compares the voltage Vₜₕ on line 3505 to an internal reference voltage V_{ref} of, e.g., 1.235V, to control output pin RES\. That is, if voltage Vₜₕ has risen above 1.235V, then pin RES\ is pulled to a logic low and remains low for the reset period Tᵣₑₛ provided at pin RP. Pin RES\ also goes low and remains low if voltage Vₜₕ dips below 1.235V for a time determined by device 350.

Pin WP is provided with capacitor C_{wp} to define a “watchdog” period T_{wp}. In an embodiment, the watchdog period T_{wp}=25*C_{wp} wherein T_{wp} is in milliseconds and capacitor C_{wp} is in nano-farads. The value 25 is selected pursuant to the specification of device 350, and the value of capacitor C_{wp} is selected to achieve the desired watchdog period of, e.g., 2 ms. That is, if device 350 does not receive the heartbeat from BMC 110 at pin WDI within a given 2 ms time-window, then device 350 asserts an appropriate signal at pin WDO\ that controls flip-flop 340 and thus the control signal on line 1125.

Pin RP is provided with capacitor Cᵣₚ to define the reset period Tᵣₑₛ at output pin RES\. In an embodiment, the reset period Tᵣₑₛ=3.125*Cᵣₚ wherein period Tᵣₑₛ is in milliseconds and capacitor Cᵣₚ is in nano-farads. The value 3.125 is selected pursuant to the specification of device 350.

If the WDI pin is not toggled or strobed within the watchdog period T_{wp}, then pin WDO\ is asserted a logical low. In an embodiment, pin WDI receives the heartbeat from BMC 110, and the watchdog period T_{wp} is set to 2 ms. Therefore, if pin WDI does not receive the heartbeat from BMC 110 for 2 ms, then pin WDO\ receives a logical low that controls flip-flop 340 and thus the control signal on line 1125.

Pin RES\ is connected to the “CLR\” pin of D flip-flop 340, and thus clears or pulls the output Q of flip-flop 340 to a logic low when pin RES\ is low. As indicated above, if voltage Vₜₕ at pin Rₜₕ has risen above 1.235V, then pin RES\ is pulled to a logic low and remains low for the reset period Tᵣₑₛ provided at pin RP. The logic low of pin RES\ ensures that output Q of flip-flop 340 defaults to a logic low. Pin RES\ also goes low and remains low if voltage Vₜₕ dips below 1.235V for a time determined by device 350. Since pin Rₜₕ is connected to the standby power V_{stdby}, and if this standby power falls below 1.235V, which indicates a power fault, then system 130 may be turned off once the reset time-period determined by device 350 has expired.

Pin WDO\ is connected to the clock pin of flip-flop 340. While at a logic high and being asserted a logic low, pin WDO\ triggers flip-flop 340 to pass the D input to the Q output and thus asserts the control signal on line 1125 to control system 130.

### Timing Diagram Illustrating the Operation of System 100 that uses Circuit 300A

FIG. 3B shows a timing diagram 300B illustrating the operation of system 100 that uses control circuit 300A, in accordance with an embodiment. For illustration purposes, BMC 110, control circuit 300A, and system 130 receive a valid V_{stdby} at time t₁; the reset period Tᵣₑₛ is set at 500 ms, which starts at time t₁ and ends at time t₂; the watchdog period T_{wp} is set at 2 ms; and BMC 110 completes its initialization at time t₃. Because a long time of 500 ms elapses between time t₁ and t₂, BMC 110 should have generated a heartbeat signal by time t₂.

At time t₂, if the heartbeat signal has not been generated, e.g., the signal is not pulsing, then device 350, after another watchdog period T_{wp} of 2 ms, i.e., at time t′₂, asserts the WDO\ signal, which in turn asserts the control signal on line 1125 to turn on system 130. As shown in FIG. 3B, at time t′₂, WDO\ turns low and asserts a high on the control signal on line 1125. In this example, system 130 is turned on after a predefined time window of Tᵣₑₛ plus T_{wp} .

However, if, at time t2, the heartbeat signal is pulsing, i.e., the heartbeat has been generated, then BMC 110 continues its initialization and is ready to function and/or completes its initialization at time t₃. At that time, BMC 110 de-asserts the heartbeat signal, e.g., for it to stay at a low level. In accordance with the operation of device 350, after the watchdog period T_{wp} of 2 ms from time t₃, i.e., at time t′₃, WDO\ turns low and asserts high on the control signal on line 1125.

### The Reset Circuit and Vₜₕ

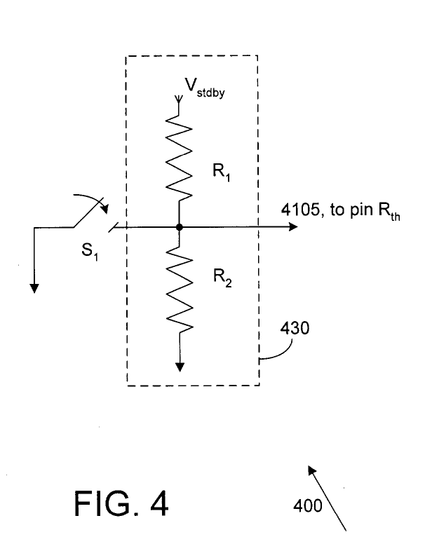

FIG. 4 shows a circuit 400 that may be used to provide voltage Vₜₕ and to reset circuit 130, in accordance with an embodiment. Circuit 400 includes a resistive network 430 and a switch S1.

Resistive network 430 that comprises resistors R1 and R2 provides voltage Vₜₕ as a function of voltage V_{stdby} in which Vₜₕ=V_{stdby}(R2/(R1+R2)). In general, if there is no standby power V_{stdby}, then voltage Vₜₕ is at a logical low, and, as voltage V_{stdby} is asserted, voltage Vₜₕ increases until it is greater than voltage V_{ref} of 1.235V, which is used in conjunction with pin Rₜₕ above.

Closing switch S1 causes voltage Vₜₕ to a logical low, which is less than V_{ref} of device 350, and thus causes a low at pin RES\, which in turns causes a low at the output Q of the D flip-flop on line 1125 and affects system 130 as described above.

In the examples of FIG. 2 and FIG. 3, the control signal is asserted by first providing the heartbeat signal and later revoking it. However, embodiments of the invention are also applicable when asserting the heartbeat signal asserts the control signal. For example, the heartbeat signal remains at a logic low or high, and then pulses when BMC 110 is up and running or when a predetermined time has expired. In such a situation, control circuit 120 is adjusted to adapt to such logic. Further, the active level of the control signal is selected as low and high, respectively, to show that embodiments of the invention are applicable without the limitation of that logic level or the logic level of other signals as various methods may be used to convert the logical state of a signal to a desired logical state. For example, if it is desirable that the control signal on line 1125 in FIG. 2 be asserted with a logical high, then resistor R220 is pulled-down, instead of being pulled-up. Alternatively, an inverter may be used to convert the logical state on line 1125 in FIG. 2 and FIG. 3. Additionally, other mechanisms may be used in place of resistor R220 and standby power. For example, flip-flop 340 in FIG. 3 may be used in place of resistor R220 in FIG. 2 wherein line 1125 is fed into the clock input of D flip-flop 340 with appropriate level being adjusted on line 1125.

Similarly, the logical level on line 1125 in FIG. 3 may be selected as desired, e.g., by adding an inverter, and flip-flop 340 may be replaced with other circuits such as a resistor R220 connected to standby power, etc.

Embodiments of the invention are advantageous over other approaches because even if BMC 110 does not power on, system 130 can still be powered on after a relatively expeditious, predetermined period, and thus avoids single-point failure problems. System 130 being on without BMC 110 can still function normally, except for those utilities that are provided by BMC 110. However, when BMC 110 is on and ready, BMC 110 also turns on system 130. Because system 130 can be turned on based on the status of the heartbeat of BMC 110 without being directly affected by firmware in BMC 110, changing this firmware is transparent to using circuit 120 to control system 130.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

What is claimed is:

1. A control circuit for controlling a first circuit, comprising:
an input for receiving a heartbeat signal from a second circuit; and
an output for providing a control signal that controls the first circuit;
wherein
the control circuit monitors the heartbeat signal and asserts an appropriate signal to the control signal when the second circuit revokes the heartbeat signal or the second circuit does not produce the heartbeat signal within a predefined time-window.

2. The control circuit of claim 1 wherein the second circuit provides the heartbeat signal before a predefined time period expires.

3. The control circuit of claim 2 wherein the time period starts when the control circuit, the first circuit, and the second circuit simultaneously receive standby power.

4. The control circuit of claim 3 wherein the second circuit revokes the heartbeat signal upon completion of the second circuit's initialization.

5. The control circuit of claim 1 wherein the control circuit starts the time-window when the control circuit receives standby power and asserts the appropriate signal to the control signal at the end of the time-window.

6. The control circuit of claim 1 being implemented in one or a combination of programmable logic device and discrete logic devices.

7. The control circuit of claim 1 wherein the first circuit is the hardware system of a server.

8. The control circuit of claim 7 wherein the second circuit is compliant with the Intelligent Platform Management Interface standard for monitoring and controlling the server.

9. The control circuit of claim 7 wherein the second circuit is a service processor providing services for the server.

10. A method for using a control circuit to control a first circuit, comprising:
using a second circuit to provide a heartbeat signal to the control circuit; and
based on the heartbeat signal, the control circuit asserting a control signal to control the first circuit;
wherein the control circuit asserts the control signal either when the heartbeat signal indicates to the control circuit that the second circuit is ready to function or when a predefined time window has expired.

11. The method of claim 10 wherein asserting the control signal turns on the first circuit and de-asserting the control signal turns off the first circuit.

12. The method of claim 11 wherein the control circuit de-asserts the control signal when a switch that is connected to an input of the control signal is closed for a predetermined time.

13. The method of claim 10 wherein the control circuit de-asserts the control signal when the control circuit receives a voltage level below a pre-determined threshold for a predetermined time.

14. The method of claim 10 wherein the control circuit asserts the control signal when:
the heartbeat signal remains at a logic level and then pulses when the second circuit is ready to function; or
the heartbeat signal pulses and then turns to a logic level when the second circuit is ready to function.

15. The method of claim 10 wherein the control circuit asserts the control signal upon completion's of the second circuit initialization.

16. The method of claim 10 wherein the predefined window starts when the control circuit, the first circuit, and the control circuit simultaneously receive standby power.

17. The method of claim 10 wherein:
the control circuit being implemented using a watchdog timer device,
the heartbeat signal is provided to a first input of the watchdog timer device to control a first output of the watchdog timer device based on a time provided from a second input of the watchdog timer device, and
the predefined time window is programmed pursuant to the specification of the watchdog timer device.

18. The method of claim 17 wherein the first output of the watchdog timer device is provided to a clock input of a flip-flop, a resistor being pulled-up, or a resistor being pulled-down.
